(19) United States
(12) Patent Application Publication
(10) Pub. No.: US 2005/0273353 A1
(43) Pub. Date: Dec. 8, 2005

(54) Mandate compliance system, apparatuses, methods and computer-readable media

(75) Inventors: Ian O'Brien, Atlanta, GA (US); W. Phillip McCurdy, Norcross, GA (US); James A. Walker, Atlanta, GA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Automated Compliance Technologies, Inc.

(21) Appl. No.: 11/134,071

(22) Filed: May 20, 2005

Related U.S. Application Data
(60) Provisional application No. 60/573,073, filed on May 21, 2004.

(51) Int. Cl. G06F 17/60

(52) U.S. Cl. 705/1

(57) ABSTRACT

The invention is directed to a mandate compliance system, apparatuses, computer-readable media, and methods which strongly encourage a mandatee or probationer under order from a court to comply with the terms of the mandate. If the mandatee fails to comply with terms of a court order, then the mandatee loses the use of a controlled device. The controlled device can be his/her automobile or television set, for example. In some embodiments, a compliance device, such as a code-activated ignition lock, is installed into an automobile as the controlled device. Activation codes effective for limited periods of time are provided to the mandatee or probationer sequentially over time as long as such person meets milestones or scheduled performance under the mandate. The immediacy of deprivation of use of a controlled device motivates the mandatee to comply with the terms of the mandate.

### CROSS-REFERENCE TO RELATED APPLICATIONS

This patent application is a U.S. nonprovisional application filed pursuant to Title 35, United States Code §§100 et seq. and 37 C.F.R. Section 1.53(b) claiming priority under Title 35, United States Code §119(e) to U.S. provisional application No. 60/573,073 filed May 21, 2004 naming Ian O'Brien, W. Phillip McCurdy and James A. Walker as inventors. U.S. Provisional Application No. 60/573,073 is incorporated by reference into this application as if set forth in full hereinafter. Both the subject application and its provisional application have been or are under obligation to be assigned to the same entity.

### BACKGROUND OF THE INVENTION

1. Field of the Invention

This invention relates to a mandate compliance system that can be used to strongly encourage a mandatee or probationer under a mandate from a court to comply with the terms of the mandate.

2. Description of the Related Art

In the administration of justice, courts often require a civil or criminal defendant to comply with terms of a mandate of the court. As used herein, one who is subject to a court mandate is referred to herein as a ‘mandatee’. The civil or criminal defendant normally consents to the terms of the mandate in lieu of harsher penalty or fine, thereby becoming a mandatee subject to the court order. For example, the court may require the mandatee under the terms of the mandate or probation agreement to do one or more of the following: (1) report to a probation officer at specified dates and times; (2) pay a probation supervision fee; (3) abstain from alcohol and/or drug use; (4) do not enter establishments where alcohol is served; (5) perform prescribed hours of community service; (6) appear for an alcohol and/or drug evaluation; (7) attend drug or alcohol counseling; (8) attend anger management counseling sessions. All too often, however, some mandatees will fail to comply with the terms of the mandate to which they are subject. Once the mandatee has left the courthouse, the threat of immediate punishment or deprivation of privileges can diminish to the point that the mandatee fails to comply with the terms of his/her mandate. Although the mandatee is generally aware that law enforcement authorities may eventually arrest the mandatee at which time they will be subject to harsher penalties and fines for noncompliance, mandatees in many cases run that risk. It would be desirable to provide a system and method that can force a mandatee to comply with the terms of a mandate to which they are subject through more immediate deprivation of privileges in the event of noncompliance with a mandate.

Also related to this invention are ignition lock devices that have been used in the car rental and sales industry. To obtain payment from lessees/purchasers of automobiles, especially those who are at high risk of default on lease or purchase agreements involving financing, the vehicles are provided with code-activated ignition lock devices. Such devices are commercially available from numerous sources. For example, Pacific Insights, Inc. produces a device sold under the PastTime trademark, Pay Teck, Inc. produces a payment control device, and Payment Protection Systems, Inc. produces a device sold under the OnTime trademark. When the purchaser makes a payment each month, the purchaser is provided with the code that will operate the car for the next month. Thus, because the purchaser/lessee does not have use of the car if a payment is not made, the user is particularly motivated to make payments because loss of use of the car is relatively immediate as compared to the alternative process of repossession. It would be desirable if the incentive to take action made possible with the code-activated ignition lock device could be applied to other contexts to produce beneficial results.

### SUMMARY OF THE INVENTION

The disclosed system, apparatuses, computer-readable media, and methods, in their various embodiments, each overcome one or more of the above-mentioned problems, and achieve additional advantages and benefits as hereinafter set forth.

This invention is a mandate compliance system, apparatuses, computer-readable media, and methods that can be used to strongly encourage a mandatee or probationer under order from a court to comply with the terms of the mandate. More particularly, if the mandatee fails to comply with terms of a court order, then the mandatee loses the use of a controlled device such as his/her automobile or television set, for example. The immediacy of deprivation of use of a controlled device motivates the mandatee to comply with the terms of the mandate.

### BRIEF DESCRIPTION OF THE DRAWINGS

Having thus described the invention in general terms, reference will now be made to the accompanying drawings, which are not necessarily drawn to scale, and wherein:

FIG. 1 is a mandate compliance system and method in accordance with an embodiment of the invention.

FIG. 2 is a view of a code-activated compliance device installed in a vehicle to ensure compliance with a court-ordered mandate in accordance with the invention.

FIG. 3 is a block diagram of an installer computer enabling an installer to program a compliance device with activation codes and corresponding dates during which respective activation codes can be used to operate the compliance device.

FIG. 4 is a block diagram of a compliance authority computer for administering a mandate.

FIG. 5 is a flowchart of a general method of the invention for enforcing compliance with a mandate through the use of a compliance device.

FIG. 6 is a general flow diagram of a method performed by an installer of a compliance device.

FIGS. 7A and 7B are a relatively specific flow diagram of a method for enforcing compliance with a court order through the use of a code-activated compliance device in accordance with an embodiment of the invention.

### DESCRIPTION OF THE PREFERRED EMBODIMENTS

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

### Definitions

‘And/or’ means ‘one, some, or all’ of the things immediately preceding and succeeding this phrase. Thus, ‘A, B and/or C’ means ‘any one, some or all of A, B and C.’

“Computer” can be any device capable of receiving input data, processing that data, and generating output data. The computer can be a personal computer, laptop computer, personal digital assistant (PDA), server, mainframe, minicomputer, or any other computing device. Examples are commercially available from numerous vendors, including Dell® Corporation, Round Rock, Tex.; Hewlett-Packard® Corporation, Palo Alto, Calif., IBM® Corporation, Armonk, N.Y., Sun Microsystems, Inc., Sunnyvale, Calif., and numerous others.

“Input Device” can be a keyboard, mouse, pen, stylus or other device used to input data into a computer.

‘Mandate’ refers to a court order that provides a set of compliance actions and a schedule of due dates and optionally times for each action to be taken by a mandatee in order to comply with the mandate.

‘Mandatee’ refers to a person who is subject to a court mandate with compliance terms.

‘Memory’ or ‘computer-readable medium’ refers to virtually any element capable of storing data and/or code that can be read by a processor. “Memory’ or ‘computer-readable medium’ includes within its meaning a random-access memory (RAM) such as synchronous dynamic access RAM (SDRAM), read-only memory (ROM), flash memory, compact disc (CD), digital video disc (DVD), hard disk drive unit, disk storage unit, magnetic tape, etc.

“Network” is a group of computers and associates devices connected to communicate with on another, and can refer to a local area network (LAN), wide area network (WAN), metropolitan area network (MAN), Ethernet, Fast Ethernet, SONET, the Internet I and II, etc.

‘Operating system’ enables a processor to communicate with other elements of a computing device. The operating system can be one of the systems sold under the marks Windows® CE, Palm OS, DOS, Windows® 95, Windows® 98, Windows® 2000, Windows® NT, Windows® XP, OS/2, OS/360, OS/400, iSeries, eSeries, pSeries, zSeries, UNIX, LINUX, and numerous others.

“Output device” can be a monitor, browser display, light, liquid crystal display (“LCD”), light-emitting diode (LED), diode array, flat panel display, cathode ray tube (“CRT”), speakers, or other device for generating a display, sound and/or other presentation based upon the execution of a computer program by the processor.

‘Processor’ can be virtually any element capable of processing data, including a microprocessor, microcontroller, programmable gate array (PGA), field programmable gate array (FPGA), programmable logic array (PLA), programmable array logic (PAL), etc. The processor can be configured to process data in any electromagnetic-form including electrical, optical, electro-optical, or magnetic data, for example.

‘(s)’ or ‘(ies)’ means one or more of the thing meant by the word immediately preceding the phrase ‘(s)’. Thus, “key(s)” means “one or more keys.”

### General System and Method

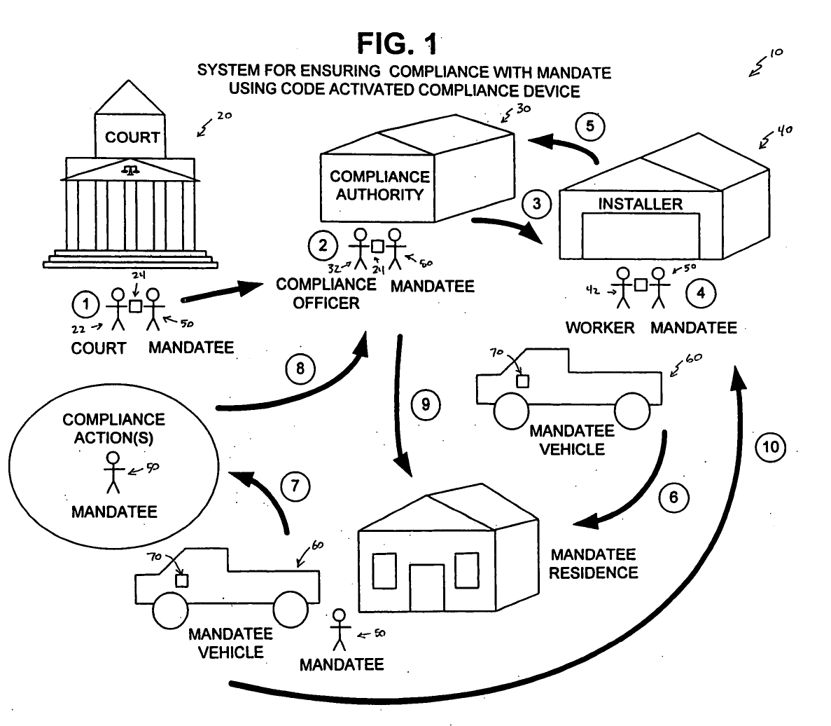

An embodiment of the invention is now disclosed with reference to FIG. 1. The system 10 and method utilizing the same generally involves four entities: court 20; compliance authority 30; installer 40; and mandatee 50. In this embodiment, the controlled device 60 is a vehicle. The system 10 and method utilizing same generally comprises the following steps:

(1) The court 20 issues a mandate 24 with terms requiring the mandatee 50 to take certain compliance actions according to a schedule set by the court. A court officer 22 provides the mandatee with the mandate 24 including these terms. For example, these terms can include on or more of the following: report to a compliance officer at specified dates and times; pay a probation or mandate supervision fee; abstain from alcohol and/or drug use; do not enter establishments where alcohol is served; perform prescribed hours of community service; appear for an alcohol and/or drug evaluation; attend drug or alcohol counseling; and/or attend anger management counseling sessions.

(2) The mandatee 50 meets with a compliance officer 32 of the compliance authority 30. This compliance authority 30 is generally a contractor of the court 20 who is charged with administration of court-ordered mandates. The compliance officer 32 advises the mandatee 50 of the terms of compliance under the mandate 24 and instructs the mandatee 50 to take his/her vehicle to a certified installer 40 for installation of a compliance device 70, in this embodiment a code-activated ignition lock device.

(3) The compliance authority 30 advises the installer 40 of the schedule of compliance dates required by the mandate 24, and requests the installer 40 to program a compliance device with activation codes according to the schedule of dates in the mandate.

(4) The mandatee 50 takes his/her controlled device 60, in this embodiment a vehicle, to the installer 40. The installer 40 installs the code-activated compliance device 70. The installer 40 further programs the compliance device 70 with activation codes that are only usable for a defined period corresponding to the schedule of compliance actions required by the mandate 24 provided through the compliance authority 30. The compliance device 70 is such that the mandatee 50 must enter the activation code in order to use the controlled device 60. Thus, in this embodiment, the user must enter an activation code in order to start the vehicle 60. However, the rest of the compliance codes programmed into the compliance device 70 are not provided to the mandatee 50. Thus, the mandatee 50 only has an activation code that is effective until the next check point in time at the end of the compliance period underway, at which the compliance authority 30 determines whether the mandatee 50 has complied with the mandate 50 for the action(s) required by the mandate 24 in the previous compliance period.

(5) The installer provides the activation codes and schedule to the compliance authority 30. The compliance authority 30 now has the activation codes needed for the mandatee 50 to operate the controlled vehicle 60.

(6) The mandatee 50 next returns to his/her everyday routine, except that the mandatee 50 must take compliance actions pursuant to the mandate 24 as prescribed.

(7) The mandatee 50 takes compliance actions according to the schedule set forth in the mandate 24. Thus, the mandatee 50 can be required to report to a compliance officer at specified dates and times; pay a probation or mandate supervision fee; abstain from alcohol and/or drug use; refrain from entering establishments where alcohol is served; perform prescribed hours of community service; appear for an alcohol and/or drug evaluation; attend drug or alcohol counseling; and/or attend anger management counseling sessions.

(8) The compliance authority monitors the mandatee's compliance with the terms of the mandate 24 to ensure that the mandatee 50 has taken the necessary compliance action(s). The system can be set up so that only in the event the mandatee fails to perform a required compliance action is the compliance authority 39 notified of the mandatee's noncompliance. Such notification of noncompliance will be manifestly clear to the compliance authority 30 in many cases. For example, if the mandatee 50 fails to report to the compliance officer 32, or fails to pay the compliance authority 30 an administration fee (e.g., for installation and use of the compliance device 70), then it is apparent to the compliance authority 30 that the mandatee 50 has not complied with an action required by the mandate 24. In other cases, a third party can report noncompliance. For example, a third party entity administering community service, alcohol or drug testing, or counseling can report any failure to perform work, subject himself/herself to testing, or to attend a meeting required under the mandate 24. In addition, law enforcement officers and others can report a failure on the part of the mandatee 50 to abstain from alcohol and/or drug use, or failure to avoid establishments where alcohol is served.

(9) The compliance authority 30 provides the mandatee 50 with activation codes required to operate the controlled device 70. This can be done through a telephone call application administered by the compliance authority 30, into which the mandatee 50 can call to receive the next activation code for the compliance device 70 shortly prior to expiration of the activation code in use. However, this does not exclude provision of the activation code to the mandatee 50 through any known communication means, such as a telephone call, mailed notification, emailed notification, secure website, or other means. Alternatively, if the compliance authority 30 determines that the mandatee 50 has failed to take a required compliance action, the compliance authority 30 notifies the court 20 and mandatee 50 of the non-compliance with the terms of the mandate 24. No further activation codes will be provided by the compliance authority 30 to the mandatee 50 in this circumstance, and the mandatee 50 must then return to the court 20 for any further disposition of the mandate 24.

(10) The mandatee 50, compliance authority 30, and any involved third parties continue the cycle of steps (7)-(9) until the last required compliance step has been taken by the mandatee 50. The mandatee 50 then returns to the installer 40 with the vehicle 60 for extraction of the compliance device 70. The mandatee 50 has thus completed the actions required by the mandate 24 by the required due dates, and is thus free to return to his/her normal life without the need to perform any further compliance actions under the mandate 24.

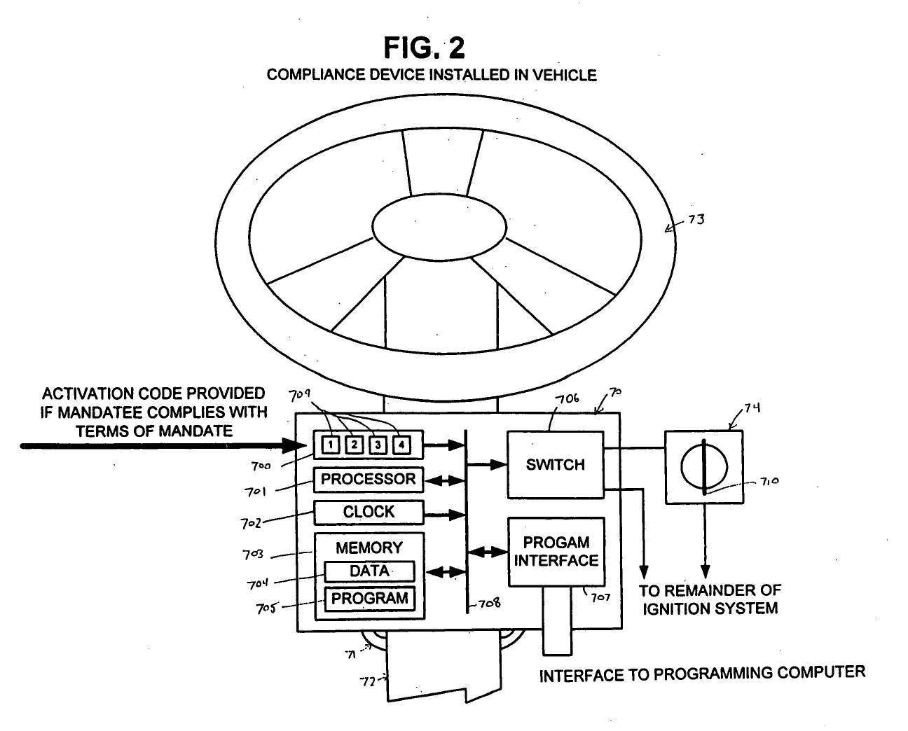

In FIG. 2 an exemplary installation of the compliance device 70 in a controlled device, in this embodiment, a vehicle, is shown. The compliance device 70 can be mounted with a metal or plastic bracket or strap 71 to the steering column 72 to which the steering wheel 73 is attached. The compliance device 70 is connected in series with the ignition switch 74 and the remainder of the ignition system including the vehicle battery, fuse, and starter. The compliance device 70 can comprise a keypad 700, a processor 701, a clock 702, a memory 703 storing data 704 and program 705, switch 706, program interface 707, coupled to bus 708. The compliance device 70 can be programmed by the compliance authority 30 using a computer (not shown) which connects to the program interface 707 of the compliance device 70. The processor 70 receives schedule data 703 with activation codes and respective times of activation corresponding with the due dates of compliance actions to be taken by the mandatee 50. The processor 701 executes program 705 stored in its memory 703, causing it to store the received activation codes and corresponding activation times in its memory 703 as data 704. Once the compliance device 70 is programmed, the mandatee 50 is provided with activation codes as the mandatee progresses through the compliance actions required under mandate 24. If the mandatee 50 desires to operate the controlled device or vehicle 60, the mandatee 50 operates keys 709 to enter the activation code. For example, if the activation code were “241321” then the mandatee 50 operates the keys 709 to enter this number into the 700. In response to operation of the keypad 700 the processor 701 retrieves the activation code corresponding to the time as determined by clock 702 from the data 703 stored in the memory 703. If the processor 701 determines that the activation code entered by the mandatee 50 using the keys 709 of the keypad 700 matches the activation code stored as data 703 in the memory 703 for the corresponding date and/or time indicated by the clock 702, then the processor 701 activates the switch 706, under its execution of the program 705. This permits the mandatee 50 to activate the vehicle starter by turning key 710 in ignition switch 74, causing the battery to power the starter to start the vehicle's engine. Conversely, if the mandatee 50 an activation code that the processor 701 does not match the corresponding activation code stored in the memory 703 corresponding to the time of entry of the activation code, the processor 701 does not activate the switch 706 to close the ignition circuit so that the mandatee 50 cannot start the vehicle even if the key 70 is turned in the ignition switch 74. Because the mandatee 50 can only continue to receive usable activation codes by complying with compliance actions required under the mandate 24, the mandatee 50 is highly motivated to take the required actions because noncompliance deprives him/her of the use of the controlled device, in this case, the vehicle 60. Most mandatees 50 will prefer to take required compliance actions rather than be deprived of the use of the controlled device 70.

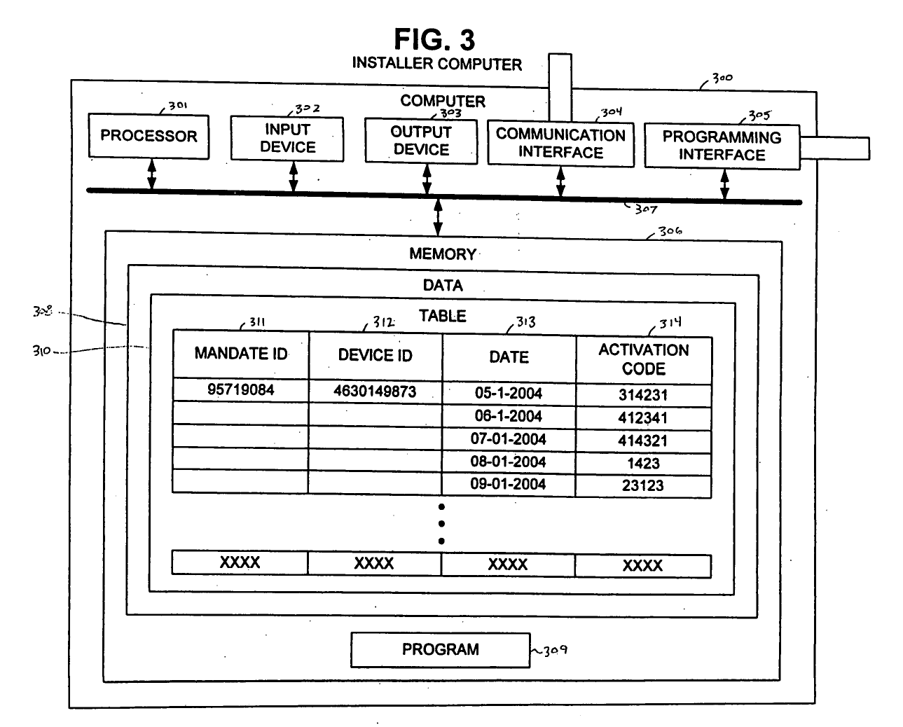

FIG. 3 is a block diagram of an installer computer 300 in accordance with an embodiment of the invention. The computer 300 generally comprises processor 301, input device 302, output device 303, communication interface 304, programming interface 305, and memory 306 coupled via bus 307. The memory 306 contains data 308 and computer program 309 that the processor 301 executes in order to perform the functions described herein. The data 308 contains a table 310 storing mandate identification (ID) data 311, device ID data 312, date data 313, and activation code data 314. The mandate ID data 311 identifies the particular mandate 24 to which the mandatee 50 is subject. The device ID data 312 Indicates the identification number of the compliance device 70 assigned to the mandatee 50. The date data 313 indicates the start date for use of a corresponding activation code indicated by associated data 314. These dates correspond to the schedule of compliance actions set forth in the mandate. Thus, the table 310 indicates that mandatee 50 subject to the mandate 24 identified by the data 311 having value “95719084” has been assigned the compliance device 70 having identification number “4630149873” which has activation codes “314231”, “412341”, “414321”, “1423”, “23123” indicated by data 312 which are effective for one month starting on respective dates “05-01-2004”, “06-01-2004”, “07-01-2004”, “08-01-2004”, “09-01-2004” as indicated by the data 314. The input device 302 (such as a keyboard and/or mouse) and the output device 303 (such as a monitor or display) enable the worker 42 of the installer 40 to interact with the computer 300 to enter, modify, and/or delete the data 311-314 as appropriate. The communication interface 304 (such as a network interface card (NIC) or modem) enables the computer 300 to communicate with the computer of the compliance authority 30. The communication interface 304 can be coupled to communicate with the computer of the compliance authority 30 via a network. The programming interface 305 enables the processor 301 to retrieve the compliance device ID data 312 and to program the compliance device 700 with the dates/times and corresponding activation codes indicated by data 313, 314.

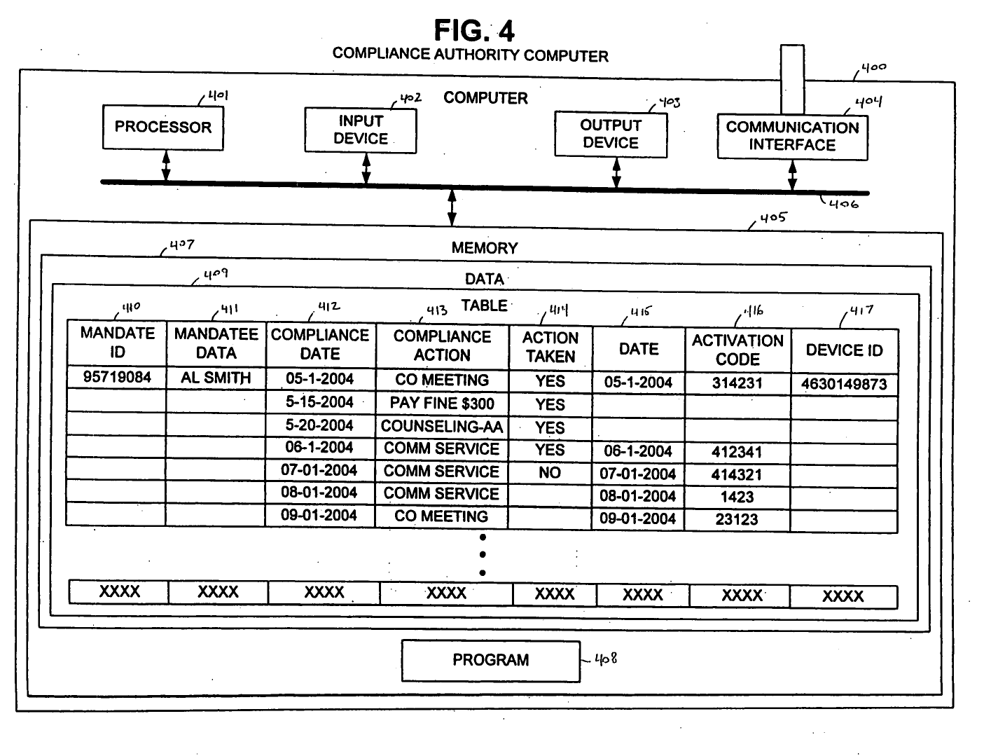

FIG. 4 is a diagram of a compliance authority computer 400 used by the compliance authority 30 to administer the mandate 24. The computer 400 comprises a processor 401, an input device 402, an output device 403, a communication device 404, and a memory 405, coupled to communicate via the bus 406. The memory 405 stores data 407 and program 408 which the processor 401 executes in order to perform the functions herein described as associated with the computer 400. In particular the processor 401 executes the program 408 to receive the mandate ID data 410, the mandatee data 411 (mandatee name, driver's license number, social security number, address, telephone number, email address, or other contact information), compliance date data 412 which sets the date and/or time by which the mandatee 50 must take a compliance action, compliance action data 413 which describes the nature of the compliance action required of the mandatee 50, action taken data 414 which indicates whether the mandatee 50 took the action by the required date, date data 415 which indicates the start date for use of a corresponding activation code indicated by data 416, and device ID data 417 indicating the particular compliance device 70 installed in the controlled device 60 of the mandatee 50. The computer 400 can be coupled via communication interface 404 to receive the data 410, 411, 412, 413 from the court computer system or can be entered into the computer 400 by the compliance officer 32 according to the mandate 24 by operating the input device 402 using the output device 403. The processor 401 receives and stores this date in the memory 405 as it executes the program 408. The computer 400 can also interrogate and receive data 410, 415, 416, 417 from the installer computer 300 to obtain the activation codes 416 and effective dates 415 for use of each code once the installer 30 has programmed the compliance device 70 for installation in the controlled vehicle 60. The data 414 can be input by the compliance officer 32 or received from third parties as the compliance authority 30 monitors the mandatee 50 to determine whether the mandatee 509 has taken the required compliance actions indicated by data 413 by the due dates indicated by the data 415. For example, in the exemplary embodiment of FIG. 4, the mandatee 50 is required to take three actions in the month of May 2004, namely, to attend a meeting with the compliance officer 32 on May 1, 2004, to pay a fine of US $300 by May 15, 2004, and to attend counseling for alcohol abuse on May 20, 2004. In addition, the mandatee 50 took the required compliance action of performing community service on Jun. 1, 2004 as required. The mandatee 50 has complied with all required compliance actions by the due date, so the compliance authority 30 provides the activation code “412341’ so that the mandatee 50 can continue to use the controlled device 60 in the month of June 2004. However, on Jul. 1, 2004, the mandatee 50 fails to attend a scheduled meeting with the compliance officer 32. The compliance authority 30 thus does not provide the mandatee 50 with the activation codes 416 for the month of July 2004 and subsequent months so that the mandatee 50 can no longer activate the compliance device 70, thereby preventing use of the controlled device 60. The mandatee 50 is thus motivated to come back into compliance with the terms of the mandate 24 if the court 20 will so permit because the mandatee 50 cannot operate his/her vehicle 60 without the necessary activation code.

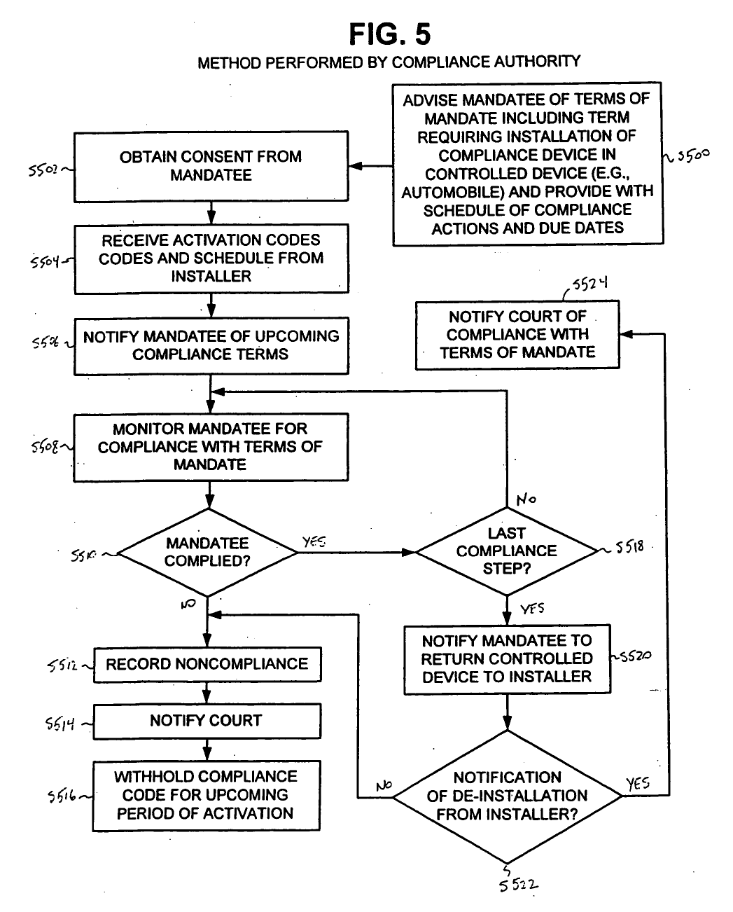

FIG. 5 is a flow diagram of a method performed by the compliance authority 30 in one embodiment of the invention. In Step S500, the compliance authority 30 advises the mandatee 50 of the terms of the mandate 24 including the term requiring installation of a compliance device 70 in the controlled device 60 (a vehicle in this embodiment). The compliance authority 30 further provides the mandatee 50 with a schedule of compliance actions and respective due dates. In Step S502 the compliance authority 30 obtains consent from the mandatee 50 to the terms of the mandate 24, one of the terms including installation of the compliance device 70 in the vehicle 60. In Step S504 the compliance authority 30 receives the activation codes and schedule from the installer 40 after the mandatee 50 has taken the controlled vehicle 60 to the installer 40 for installation of the compliance device 70 programmed with activation codes according to the schedule of compliance actions. In Step S506 the compliance authority 30 notifies the mandatee 50 of upcoming compliance actions and due dates. This is an optional step and need not be performed because the compliance actions were previously provided to mandatee 50 along with the mandate 24 in Step S500. As with other notifications herein, the compliance authority 30 can provide notification to the mandatee by any known means, including posting to a secured website accessible to the mandatee by entry of a user name and password, by email notification, by telephone notification, by mail, etc. In Step S508 the mandatee 50 is monitored for compliance with the terms of the mandate 24. In Step S510 the compliance authority 30 determines whether the mandatee 50 has complied with all compliance actions required in the compliance period. If not, the compliance authority 30 records the noncompliance and in Step S514 notifies the court of the noncompliance. In Step S516 the compliance authority 30 withholds any further activation codes so that the mandatee 50 is deprived of the use of the controlled vehicle 50 at the end of the compliance period underway. Hence, the activation code necessary to activate compliance device 70 for the next compliance period is not be provided to the mandatee 50 by the compliance authority 30. Conversely, if in Step S510 it is determined that the mandatee 50 has taken the compliance actions by the due dates required under the mandate 24, then in Step S518 the compliance authority 30 determines whether the last compliance step required under the mandate 30 has been taken. If not, then the compliance authority 30 executes Step 508 and subsequent steps again. Conversely, if the compliance authority 30 determines that the last compliance step has been taken in Step S518, the compliance authority 30 notifies the mandatee 50 to return the vehicle 60 to the installer 40 for de-installation of the compliance device 70 in Step S520. If in Step S522 the compliance authority 30 does not receive notice from the installer 40 within a prescribed period of time that the mandatee 50 has returned to the installer 40 with the controlled device 60 to permit the installer 40 to de-install the compliance device 70, then the compliance authority 30 executes steps S512-516 because the mandatee 50 has not complied with a necessary term of the mandate 24, namely, to return the compliance device 70 to the installer 40. Conversely, if the compliance authority 30 receives notification from the installer 40 that the mandatee 50 has returned to the installer 40 for de-installation of the compliance device 70, then in Step S524 the compliance authority 30 notifies the court 20 that the mandatee 50 has complied with all terms of the mandate 50. The court 20 then discharges the mandatee 50 from further obligation under its mandate 24.

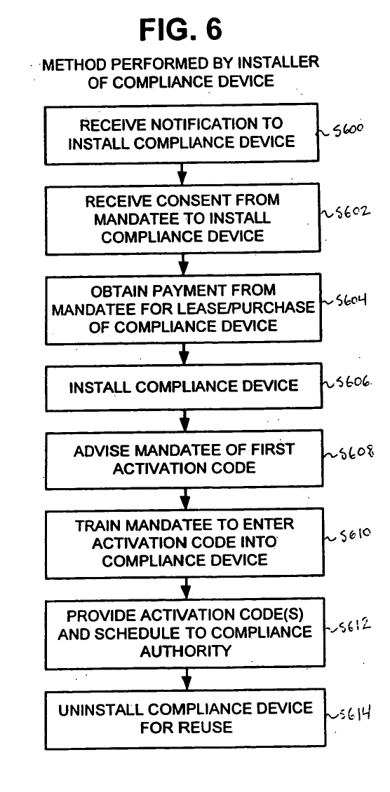

FIG. 6 is a method performed by an installer 40 of a compliance device 70 into a controlled device 60 such as a vehicle. In Step S600 the method begins with the installer 40 receiving notification from the compliance authority 30 that the mandatee 50 is required under the mandate 24 to make an appointment to have the compliance device 70 installed pursuant to the mandate 24. In Step S602, the mandatee 50 arrives at the installer's location and provides consent to installer receiving consent from the mandatee 50 to installation of the compliance device 70. It is possible for the mandatee 50 to have provided the consent prior to obtaining the mandate 24 from the court 20. In Step S604 the installer 40 obtains payment for installation of the compliance device 70 and/or leasing or purchasing the compliance device 70 from the mandatee 50. In Step S606 the installer 40 installs the compliance device 70 into the controlled vehicle 60. In Step S608 the mandatee 50 is advised of the first activation code required to operate the compliance device 70 in order to activate the vehicle. Without the activation code, the mandatee 50 cannot start the vehicle. In Step S610 the worker 42 of the installer 40 trains the mandatee 50 to enter the activation code into the compliance device 70 using the keys 709 of keypad 700 (see FIG. 2). In Step S612 the installer 40 provides the programmed activation codes and corresponding schedule of compliance periods for which each activation code is effective to the compliance authority 30. In Step S614 the installer 40 de-installs the compliance device 70 upon return of the mandatee 50 to the installer's location after completed the compliance actions required under the mandate 50.

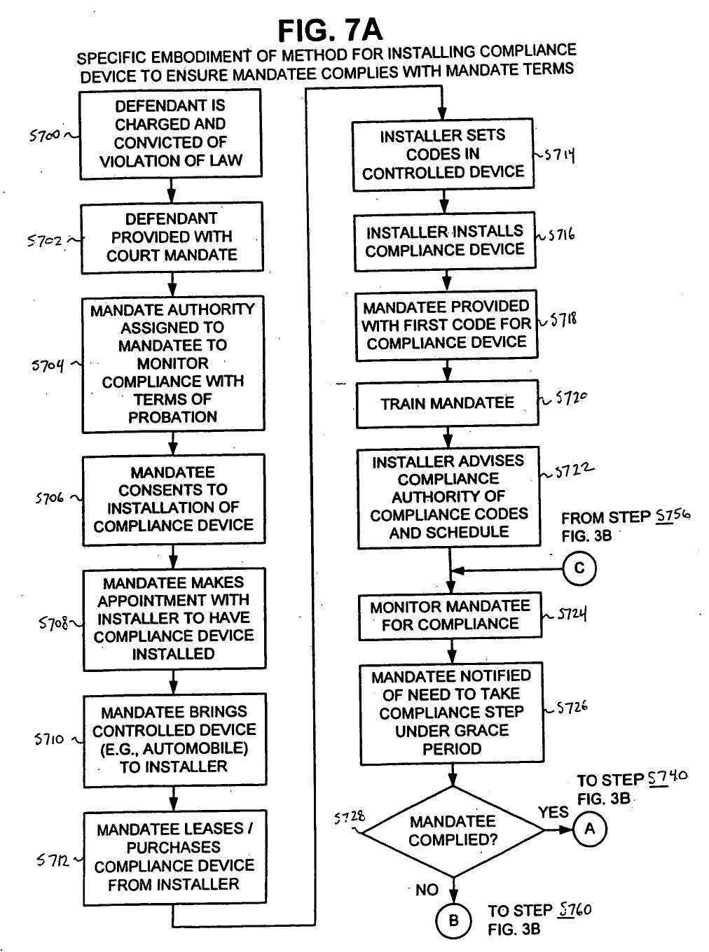

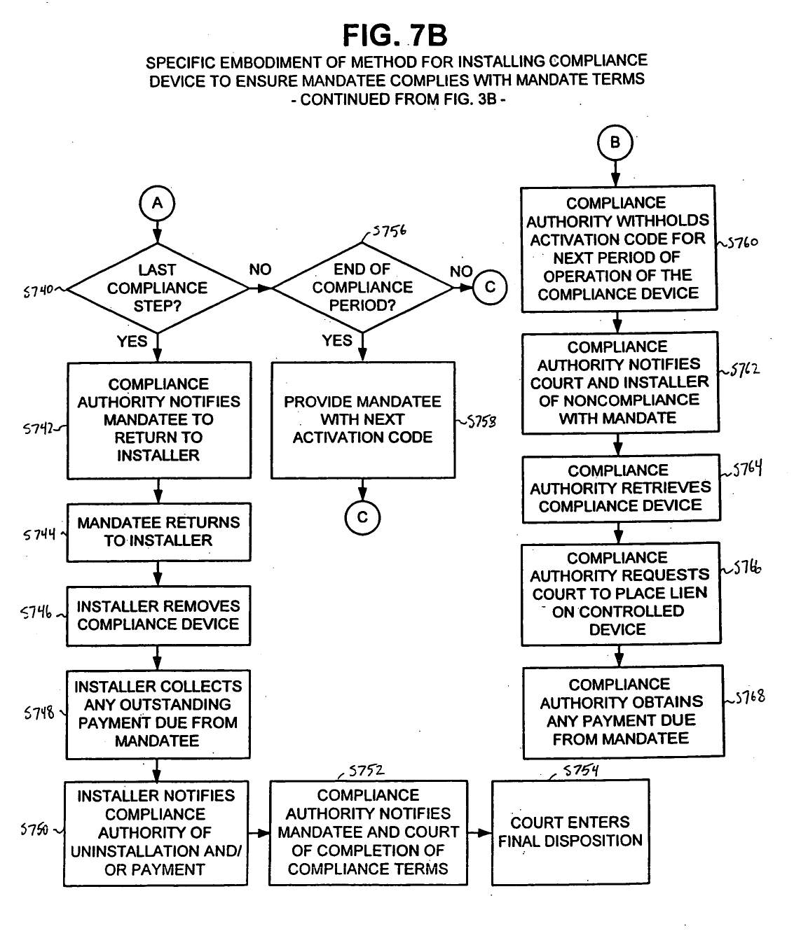

FIGS. 7A and 7B are flow diagrams of a relatively specific embodiment of a method in accordance with the invention. In Step S700 a defendant is charged with a violation of law and is convicted. Generally, in lieu of harsher sentencing, the defendant is provided with a court mandate 24 to which the defendant consents to comply, thereby becoming a mandatee 50 in Step S702. In Step S704 the compliance authority 30 is assigned by the court to administer the mandate 24 to which the mandatee 50 is subject. In Step S706 the mandatee 50 consents to installation of the compliance device 70 as one of the terms under the court mandate 24. In Step S708, as required by the mandate 24, the mandatee 50 makes an appointment with the installer 40 to install the compliance device 70 in the controlled vehicle 70. In Step S710 the mandatee 50 brings the controlled vehicle 70 to the installer's location for installation of the compliance device 70 therein. In Step S712 the mandatee 50 leases or purchases the compliance device 70 from the installer 40. In step S714 the installer 40 sets the activation codes and effective dates and/or times in the controlled device 70. In step S716 the installer 40 installs the compliance device 70 in the controlled vehicle 70. In Step S718 the installer 40 provides the mandatee 50 with the first activation code, and in Step S720 the worker 42 of the installer 40 trains the mandatee 50 to enter this activation code into the compliance device 70. In Step S722 the installer 40 notifies the compliance authority 30 of the activation codes and effective dates and/or times set in the compliance device 70. In Step S724 the mandatee 50 is monitored to determine whether the mandatee 50 has taken the compliance actions required by the due dates and/or times applicable for each action. In Step S726 if the mandatee 50 fails to take a compliance action by the due date and/or time, the mandatee 50 is notified to take a compliance action under a grace period. This is an optional step and need not be used because the mandatee 50 was previously provided with the mandate 24 in step S702 including all required compliance actions and due dates and/or times. In Step S728 a determination is made to establish whether the mandatee 50 has complied with the compliance action(s) for the compliance period underway within the dues dates and/or times, as required by the mandate 24. If not, in Step S730 the compliance authority 30 withholds the activation code for the next period of operation of the compliance device 70. In Step S732 the compliance authority 30 notifies the court and installer 40 of noncompliance with the mandate 24. The installer 40 attempts to retrieve the compliance device 70 in Step S734. In Step S734 the compliance authority 30 notifies the court 20 of nonpayment and requests a lien be placed on the controlled vehicle 60. In Step S738 the compliance authority 30 obtains any payment due from the mandatee 50 for use of the compliance device 70.

Conversely, if in Step S728 the compliance authority 30 determines that the mandatee 50 has complied with all compliance actions due under the mandate 24, the compliance authority 30 determines in Step S740 whether the mandatee 50 has taken the last compliance action required under the mandate 24. If not, the method proceeds to Step S752 in which a determination is made to establish whether the end of the compliance period underway has occurred. If so, in Step S742 the compliance authority 30 provides the mandatee 50 with the next activation code for the controlled device 70 so that the mandatee 50 will be able to use the controlled vehicle 70 in the next compliance period. After performance of Step S758 or if the determination in Step S756 is negative, the method progresses to Step S724 and subsequent steps. Conversely, if the determination in Step S740 is affirmative, then in Step S742 the compliance authority 30 notifies the mandatee 50 to return with the controlled vehicle 60 to the installer 40. In Step S744 the mandatee 50 returns to the installer 40 with the controlled vehicle 60. In Step S746 the installer 40 removes the compliance device 70 the controlled vehicle 60. In Step S748 the installer 30 collects any outstanding payment due from the mandatee 50 for use of the controlled device 70. In Step S750 the installer 40 notifies the compliance authority of the fact that the compliance device 70 has been removed from the controlled vehicle 60 as well as any payment received from the mandatee 50. In Step S752 the compliance authority 30 notifies the court 20 and mandatee 50 of completion of the compliance actions by the due dates and/or times required under the mandate 24. In Step S754 the court 20 enters final disposition discharging the mandatee 50 from any further obligation under the mandate 24.

If in Step S728 the determination establishes that the mandatee 50 has not complied with the terms of the mandate 24 by taking the required compliance actions, in Step S760 the compliance authority 30 withholds any further activation codes from the mandatee 50 for the next and any subsequent compliance period. In Step S762 the compliance authority S762 notifies the court 20 and the installer 40 of noncompliance with the mandate 24. In Step S764 the compliance authority S764 retrieves the compliance device 70 from the mandatee's controlled vehicle 60 if this is economically feasible. In Step S766 the compliance authority 30 requests the court 20 to place a lien on the controlled device 60, making it impossible for the defaulting mandatee 50 to receive certain government services such as vehicle registration or license renewal unless the defaulting mandatee 50 provides the compliance authority 30 with the compliance device 70 itself or restitution for the value of the compliance device 70, together with any payment then outstanding for use of the device. In Step S768 the compliance authority 30 receives, or at least attempts to receive, any payment due from the mandatee 50 for use of the compliance device 70.

In the foregoing description, it should be apparent that the memory 703 storing data 704 and program 705, the memory storing and, the memory storing and, can be implemented as computer-readable media which when executed by a computer perform the functions herein described with respect to such programs and data.

### Alternative Embodiments

Although in the embodiments disclosed herein the controlled device 60 is a vehicle, the controlled device 60 could as well be other devices such as a television set to which the mandatee 50 is deprived of use if he/she fails to comply with the terms of a mandate 24.

It should be appreciated that in some implementations of the invention, the compliance authority 30 and the installer 40 can be the same entity.

In addition, it is possible that the compliance authority 30 and compliance device 70 can be fitted with respective transceivers and antennas, enabling these devices to communicate with one another. The compliance authority 30 could then wirelessly program the compliance device 70 with a new activation code effective the next time the mandatee 50 attempts to use a controlled device.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method comprising the step of:
enforcing compliance by a mandatee with a court mandate through the use of a compliance device installed in the controlled device which requires the mandatee to enter an activation code to use the controlled device.

2. A method as claimed in claim 1 wherein the controlled device is a vehicle and the compliance device is a code-activated ignition lock device that can only be activated by the mandatee by entering an activation code effective at the time of entry in order to start the vehicle.

3. A method as claimed in claim 1 wherein the compliance device is programmed with a schedule of activation codes effective for limited periods of time, and wherein the enforcing includes the substep of administering the mandate by a compliance authority that only permits the mandatee to have access to an activation code if the mandatee has complied with the compliance action(s) required during the compliance periods corresponding to each code.

4. A method as claimed in claim 1 wherein the controlled device is a television set and the compliance device is electrically connected to the television set and only provides power to the television set if the mandatee enters the correct activation code effective for the compliance period existing at the time of entry of the respective codes.

5. A method as claimed in claim 1 wherein said enforcing includes the substep of programming the compliance device for controlling a controlled device with activation codes and dates of effective use of the activation codes, the activation codes corresponding to compliance dates of a court mandate with which a mandatee must comply in order to receive the activation code for a compliance period so that the mandatee can activate the compliance device to operate the controlled device.

6. A method comprising the step of:
monitoring compliance with a mandate by tracking compliance actions taken by a mandatee, and providing activation codes enabling the mandatee to activate a compliance device in order to use a controlled device if the mandatee has complied with compliance actions in the required times according to a schedule set forth in the mandate.

7. A method as claimed in claim 6 above wherein data indicating compliance due dates is stored in correspondence with data indicating compliance actions and data indicating whether the mandatee timely took the compliance actions, the method further comprising:
providing the mandatee with an activation code for a compliance period if the mandatee has complied with the compliance actions required for the compliance period, and not otherwise.

8. A method as claimed in claim 7 wherein data indicating the compliance actions and due dates and/or times is stored in correspondence with the activation code and start date of a compliance period for which the activation code is effective.

9. A method as claimed in claim 8 wherein the aforementioned data is further stored in connection with mandate data identifying the mandate to which the mandatee is subject.

10. A method as claimed in claim 8 wherein the data identifies the compliance device that has been installed in the controlled device of the mandatee.
